(19) United States
(12) Patent Application Publication
(10) Pub. No.: US 2025/0299431 A1
(43) Pub. Date: Sep. 25, 2025

(54) METHOD, APPARATUS, AND ELECTRONIC DEVICE FOR THREE-DIMENSIONAL SCENE GENERATION

(71) Applicant: Beijing Zitiao Network Technology Co., Ltd., Beijing (CN)

(72) Inventors: Panwang PAN, Beijing (CN); Zeming LI, Beijing (CN)

(21) Appl. No.: 19/087,557

(22) Filed: Mar. 23, 2025

(30) Foreign Application Priority Data
Mar. 22, 2024 (CN) 202410339067.1

(51) Int. Cl. G06T 15/20

(52) U.S. Cl. CPC G06T 15/205; G06T 2210/61

(57) ABSTRACT

Embodiments of the present application disclose a method and an apparatus, and an electronic device for three-dimensional scene generation. A specific implementation of the method includes: obtaining a target text, and generating a panoramic image described by the target text; obtaining multi-view information in a plurality of preset views, and generating a multi-view image in the plurality of views with the panoramic image; performing depth estimation on the panoramic image to determine a sparse point cloud corresponding to the panoramic image; and generating, based on the multi-view image, the multi-view information, and the sparse point cloud, a three-dimensional scene model described by the target text.

### CROSS-REFERENCE TO RELATED APPLICATION(S)

This application claims priority to Chinese Application No. 202410339067.1 filed Mar. 22, 2024, the disclosure of which is incorporated herein by reference in its entirety.

### FIELD

Embodiments of the present disclosure relate to the field of computer technologies, and in particular, to a method, apparatus, and an electronic device for three-dimensional scene generation.

### BACKGROUND

Artificial intelligence generated content (AIGC) refers to content generated by artificial intelligence. In terms of 3D scene generation, AIGC may be used to automatically create a realistic background environment. With the emergence of commercial mixed reality platforms and the rapid innovation of 3D graphics technologies, high-quality 3D scene generation has become one of the most important issues in computer vision. Generating a 3D scene background using AIGC has the advantages of being fast, efficient, customizable, creative, and versatile.

### SUMMARY

This section of the present disclosure is provided to give a brief overview of concepts, which will be described in detail later in the Detailed Description section. This section of the present disclosure is not intended to identify key features or essential features of the claimed technical solution, nor is it intended to limit the scope of the claimed technical solution.

According to a first aspect, an embodiment of the present disclosure provides a method for three-dimensional scene generation. The method includes: obtaining a target text, and generating a panoramic image described by the target text; obtaining multi-view information in a plurality of preset views, and generating a multi-view image in the plurality of views with the panoramic image; performing depth estimation on the panoramic image to determine a sparse point cloud corresponding to the panoramic image; and generating, based on the multi-view image, the multi-view information, and the sparse point cloud, a three-dimensional scene model described by the target text.

According to a second aspect, an embodiment of the present disclosure provides an apparatus for three-dimensional scene generation. The apparatus includes: an obtaining unit configured to obtain a target text, and generate a panoramic image described by the target text; a first generation unit configured to obtain multi-view information in a plurality of preset views, and generate a multi-view image in the plurality of views with the panoramic image; a determination unit configured to perform depth estimation on the panoramic image to determine a sparse point cloud corresponding to the panoramic image; and a second generation unit configured to generate, based on the multi-view image, the multi-view information, and the sparse point cloud, a three-dimensional scene model described by the target text.

According to a third aspect, an embodiment of the present disclosure provides an electronic device. The electronic device includes: one or more processors; and a storage apparatus configured to store one or more programs, where the one or more programs, when executed by the one or more processors, cause the one or more processors to implement the method for three-dimensional scene generation in the first aspect.

According to a fourth aspect, an embodiment of the disclosure provides a computer-readable medium storing a computer program. The computer program, when executed by a processor, causing the processor to perform the steps of the method for three-dimensional scene generation in the first aspect.

In the method and apparatus, and the electronic device for three-dimensional scene generation provided in the embodiments of the present disclosure, the target text is obtained, and the panoramic image described by the target text is generated; then, the multi-view information in the plurality of preset views is obtained, and the multi-view image in the plurality of views is generated with the panoramic image; next, depth estimation is performed on the panoramic image to determine the sparse point cloud corresponding to the panoramic image; and finally, the three-dimensional scene model described by the target text is generated based on the multi-view image, the multi-view information, and the sparse point cloud.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a flowchart of an embodiment of a method for three-dimensional scene generation according to the present disclosure;

FIG. 2A and FIG. 2B are schematic diagrams of generating a panoramic image in a method for three-dimensional scene generation according to the present disclosure;

FIG. 3 is a schematic diagram of an application scenario of a method for three-dimensional scene generation according to the present disclosure;

FIG. 4 is a schematic diagram of an embodiment of generating a panoramic image by fine tuning an original diffusion model in a method for three-dimensional scene generation according to the present disclosure;

FIG. 5 is a schematic diagram of another embodiment of generating a panoramic image by fine tuning an original diffusion model in a method for three-dimensional scene generation according to the present disclosure;

FIG. 6 is a flowchart of another embodiment of a method for three-dimensional scene generation according to the present disclosure;

FIG. 7 is a flowchart of still another embodiment of a method for three-dimensional scene generation according to the present disclosure;

FIG. 8 is a schematic diagram of a structure of an embodiment of a three-dimensional scene generation apparatus according to the present disclosure;

FIG. 9 is a diagram of an exemplary system architecture to which embodiments of the present disclosure are applicable; and

FIG. 10 is a schematic diagram of a structure of a computer system of an electronic device suitable for implementing an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

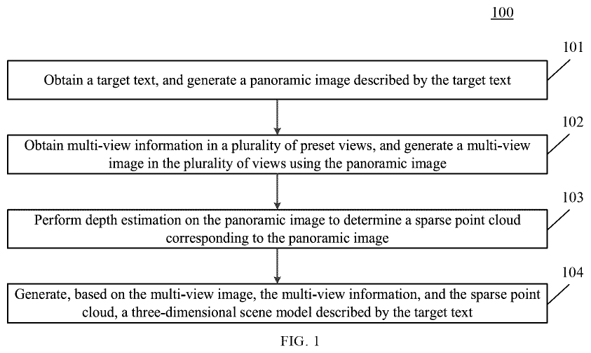

Reference is made to FIG. 1, which shows a process 100 of an embodiment of a method for three-dimensional scene generation according to the present disclosure. The method for three-dimensional scene generation includes the following steps.

Step 101: Obtain a target text, and generate a panoramic image described by the target text.

In this embodiment, an execution body of the method for three-dimensional scene generation may obtain the target text. The target text is usually a descriptive text, and the target text is usually a text determined based on an input operation of a user. As an example, the target text may be a text entered manually by the user, may be a text obtained by converting speech inputted by the user, or may be determined by the user triggering a preset control corresponding to the text. For example, a plurality of preset text controls, such as sunset, sea, and snowflakes, may be presented to the user. If the user triggers the “sunset” control, it is determined that the target text includes sunset.

Then, the execution body may generate the panoramic image described by the target text. Specifically, the target text may be inputted into a pre-trained image generation model, to obtain the panoramic image described by the target text. The image generation model is used to represent a correspondence between a text and a panoramic image described by the text, and may include, but is not limited to: a Generative Adversarial Network (GAN) and a Variational Autoencoder (VAE).

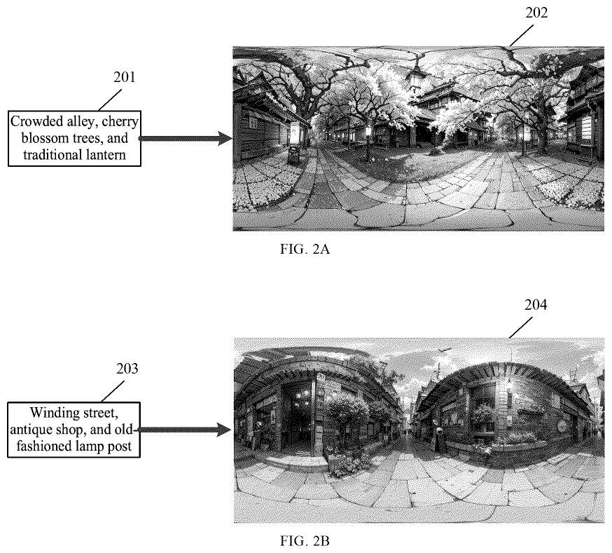

As shown in FIG. 2A and FIG. 2B, FIG. 2A and FIG. 2B are schematic diagrams of generating a panoramic image in a method for three-dimensional scene generation according to this embodiment. In FIG. 2A, when the user inputs a text “crowded alley, cherry blossom trees, and traditional lanterns” as shown in 201, a panoramic image as shown in 202 is generated. When the user inputs a text “winding street, antique shops, and old-fashioned lamp posts” as shown in 203, a panoramic image as shown in 204 is generated.

Step 102: Obtain multi-view information in a plurality of preset views, and generate a multi-view image in the plurality of views with the panoramic image.

In this embodiment, the execution body may obtain the multi-view information in the plurality of preset views, and generate the multi-view image in the plurality of views with the panoramic image. Since one view corresponds to one camera pose, the plurality of views may correspond to a plurality of camera poses, and the multi-view information may also be understood as camera pose information. Therefore, the multi-view information may include an intrinsic camera parameter and an extrinsic camera parameter.

Herein, the plurality of views may be preset. The multi-view information in the plurality of preset views is obtained, and an image in each view is determined using the panoramic image, to generate an image in each view.

Step 103: Perform depth estimation on the panoramic image, to determine a sparse point cloud corresponding to the panoramic image.

In this embodiment, the execution body may perform depth estimation on the panoramic image, to determine the sparse point cloud corresponding to the panoramic image.

Specifically, a panoramic depth D (x, y) may be estimated using a panoramic image I (x, y), and projection is performed using an intrinsic camera parameter K and extrinsic camera parameters R and t, to obtain a three-dimensional sparse point cloud.

First, pixel coordinates (x, y) may be converted to the coordinates (X_{c}, Y_{c}, Z_{c}) in a camera coordinate system.

Then, the coordinates (X_{c}, Y_{c}, Z_{c}) in the camera coordinate system may be converted to coordinates (X_{w}, Y_{w}, Z_{w}) in a world coordinate system.

Next, a sparse point cloud may be scaled based on the depth value D (x, y). In this way, a three-dimensional point corresponding to each pixel may be generated with an estimated depth of the panoramic image.

Herein, depth estimation methods such as Zero-Shot Transfer by Combining Relative and Metric Depth (ZoeDepth) or MVSNet (an end-to-end depth estimation framework based on deep learning) are used to perform depth estimation on the panoramic image.

Step 104: Generate, based on the multi-view image, the multi-view information, and the sparse point cloud, a three-dimensional scene model described by the target text.

In this embodiment, the execution body may generate, based on the multi-view image, the multi-view information, and the sparse point cloud, the three-dimensional scene model described by the target text.

Specifically, the execution body may generate, using three-dimensional reconstruction methods such as Structure From Motion (SFM) reconstruction, Neural Radiance Field (NeRF) reconstruction, and Neural Implicit Surface (NeuS) (a neural surface reconstruction method)/NeuS2 reconstruction, the three-dimensional scene model described by the target text.

In the method provided in the above embodiment of the present disclosure, the target text is obtained, and the panoramic image described by the target text is generated; then, the multi-view information in the plurality of preset views is obtained, and the multi-view image in the plurality of views is generated with the panoramic image; next, depth estimation is performed on the panoramic image to determine the sparse point cloud corresponding to the panoramic image; and finally, the three-dimensional scene model described by the target text is generated based on the multi-view image, the multi-view information, and the sparse point cloud. In this way, a panoramic image described by a text may be generated before a corresponding three-dimensional scene model, ensuring the consistency in the plurality of views and the stability of the three-dimensional scene model.

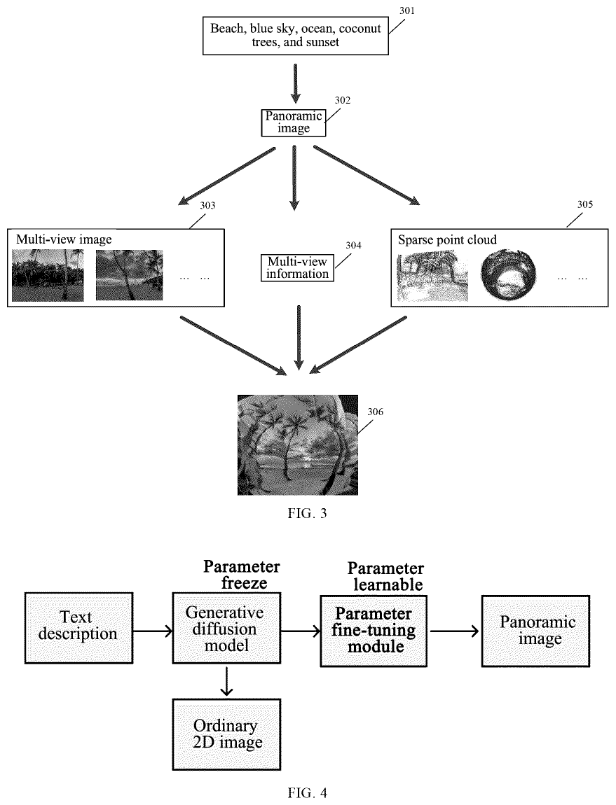

Reference is made to FIG. 3, which is a schematic diagram of an application scenario of a method for three-dimensional scene generation according to this embodiment. In the application scenario in FIG. 3, the user inputs a text “beach, blue sky, ocean, coconut trees, and sunset” as shown in reference numeral 301. Then, a panoramic image 302 described by the text is generated. Next, multi-view information 304 in a plurality of preset views is obtained, and a multi-view image in the plurality of views, as shown in reference numeral 303, is generated with the panoramic image 302. Next, depth estimation is performed on the panoramic image 302, to determine a sparse point cloud corresponding to the panoramic image 302, as shown in reference numeral 305. Finally, a three-dimensional scene model described by the text 301, as shown in reference numeral 306, is generated based on the multi-view image 303, the multi-view information 304, and the sparse point cloud 305.

In some optional implementations, the execution body may generate the panoramic image described by the target text in the following manner: generating, using a pre-trained target diffusion model (Stable Diffusion Model), the panoramic image described by the target text, where the target diffusion model is used to represent a correspondence between a text and a panoramic image. A diffusion model may also be referred to as a generative diffusion model. The diffusion model is a type of generative model, which is a type of model that can generate a composite image. The generation of the composite image by the diffusion model starts with random noise and gradually refines through a plurality of steps until an output image appears. In each step, the model may estimate how to change a current input to a denoised version.

The diffusion model outperforms networks such as a GAN and a VAE in generating new images. Specifically, the diffusion model outperforms the networks such as the GAN and the VAE in terms of a memory capacity, a degree of freedom of images, smooth transition between images, a category of the generated image, and the like. The diffusion model is effective and easy to implement, and may generate high-quality images. Therefore, combining the diffusion model with a 3D reconstruction technology can generate a better 3D image or scene required for AR/VR.

In some optional implementations, the target diffusion model is a model obtained by performing a target operation on the original diffusion model. The original diffusion model is usually used to represent a correspondence between a text and a two-dimensional image. The target operation usually includes: freezing a parameter of the original diffusion model, and inserting a learnable module into the original diffusion model, and the learnable module may be configured to convert the two-dimensional image into the panoramic image.

Generally, a neural network has both forward propagation and backward propagation. Freezing a parameter of the neural network means only performing forward propagation on the parameter of the neural network without performing backward propagation, so that the parameter is not optimized. A parameter of the inserted learnable module is optimized, and the parameter of the learnable module is learned, to adjust a generation result of the network, so that the network can complete a specific task. Herein, the learnable module can complete a task of converting the two-dimensional image into the panoramic image.

Herein, the learnable module may obtain one copy of the parameter of the original diffusion model in a controlnet manner, and perform learning on the copy of the parameter, so that the copy of the parameter may complete a specific task.

FIG. 4 is a schematic diagram of an embodiment of generating a panoramic image by fine tuning an original diffusion model in a method for three-dimensional scene generation. In FIG. 4, a text description is inputted into an original generative diffusion model, to generate an ordinary 2D image. A panoramic image corresponding to the text description is outputted by freezing a parameter of the original generative diffusion model and inserting a parameter fine-tuning module. A parameter of the parameter fine-tuning module is learnable, and a generation result of the model is adjusted by inserting the parameter fine-tuning module into the original generative diffusion model, so that the model may generate the panoramic image.

The diffusion model is a powerful technology for generating a text sample, but it has a large number of network parameters and requires a lot of training and learning. In order to reduce training time, it is proposed to freeze the parameter in the original generative diffusion model, and insert the learnable module into the model, to adjust the generation result of the model.

In some optional implementations, the learnable module may include a low-rank matrix obtained by decomposing a parameter matrix of the original diffusion model using a low-rank adaptation (LORA) technology.

FIG. 5 is a schematic diagram of another embodiment of generating a panoramic image by fine tuning an original diffusion model in a method for three-dimensional scene generation. In FIG. 5, a text x 501 is inputted into a target diffusion model 502, to obtain a panoramic image h 503. The target diffusion model 502 may being composed of an original diffusion model and a learnable module with learnable parameters.

A mathematical expression of low-rank adaptation may be represented by matrix decomposition. It is assumed that a shape of a parameter matrix W of the original generative diffusion model is d×d, where a dimension of an input feature and a dimension of an output feature are both d. Low-rank adaptation is intended to implement parameter compression and simplification by decomposing the parameter matrix W into a product of two lower-rank matrices. Such decomposition is usually implemented using Singular Value Decomposition (SVD) or other low-rank approximation algorithms. It is assumed that the parameter matrix W is decomposed into a product of two lower-rank matrices A and B, i.e., W=A×B, where A is in a shape of d×r, B is in a shape of r×d, r is a low rank, and r<<d. In this solution, A may be initialized as a standard normal distribution, and B may be initialized as 0.

In this manner, parameter compression and simplification are performed on the generative diffusion model using the low-rank adaptation technology and properties of a low-rank matrix. The parameter matrix of the original model is decomposed into a low-rank approximate expression, so that a storage requirement and computational complexity of the model may be significantly reduced. The parameter of the low-rank matrix is appropriately adjusted and updated, so that the model is effectively tuned.

In some optional implementations, the three-dimensional scene model may include a three-dimensional Gaussian radiance field (3D-Gaussian Splatting). The three-dimensional Gaussian radiance field is an explicit representation method of a 3D scene using a set of differentiable 3D Gaussian functions. Each Gaussian function is defined by a central position, a covariance matrix, a color, and an opacity. Specifically, a position and a covariance matrix of a 3D Gaussian sphere may be initialized first using a position of the sparse point cloud, and a color and an opacity of the 3D Gaussian sphere may be integrated using the multi-view image and the multi-view information. Due to the high rendering quality and high rendering speed of the three-dimensional Gaussian radiance field, in the solution described in this embodiment, a high-quality rendering result can be generated fast, improving the real-time performance of a system and the user experience.

In some optional implementations, after the initialization of the three-dimensional Gaussian radiance field, for each of the plurality of views, the execution body may project the 3D-Gaussian Splatting in to the view, compare a projected image in the view with a multi-view image corresponding to the view, to obtain a loss value, and optimize a parameter of the three-dimensional Gaussian radiance field with the loss value, until the three-dimensional Gaussian radiance field converges. That is, the central position, the covariance matrix, the color, and the opacity are optimized.

The execution body may determine the loss value using the following formula (1):

$$ℒ ( y , \hat{y} ) = {\sum }_{i = 1}^{n} \vert {y}_{i} - {\hat{y}}_{i} \vert \qquad ( 1 )$$

[symbol]

(y, ŷ) represents a total loss value, yᵢ represents an image in an i^{th} view, ŷᵢ represents an image in an i^{th} view rendered by the Gaussian radiance field, and n represents the number of views.

In this way, the parameter of the three-dimensional Gaussian radiance field can be optimized to improve the accuracy of the three-dimensional Gaussian radiance field.

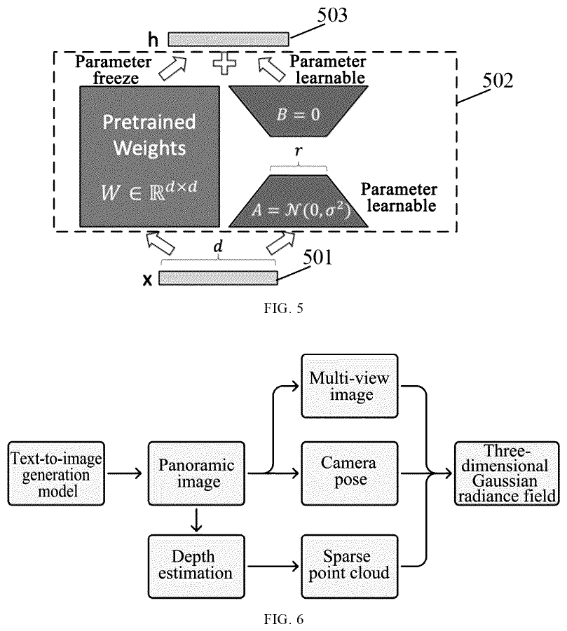

Reference is made to FIG. 6, which shows a process 600 of another embodiment of a method for three-dimensional scene generation. In FIG. 6, a target text is first inputted into a text-to-image generation model to obtain a panoramic image. Camera poses in a plurality of views are obtained, and a multi-view image in the plurality of views is generated using the panoramic image. Depth estimation is performed on the panoramic image to determine a sparse point cloud. Then, a three-dimensional Gaussian radiance field described by the target text may be outputted based on the multi-view image, the corresponding camera pose, and the sparse point cloud.

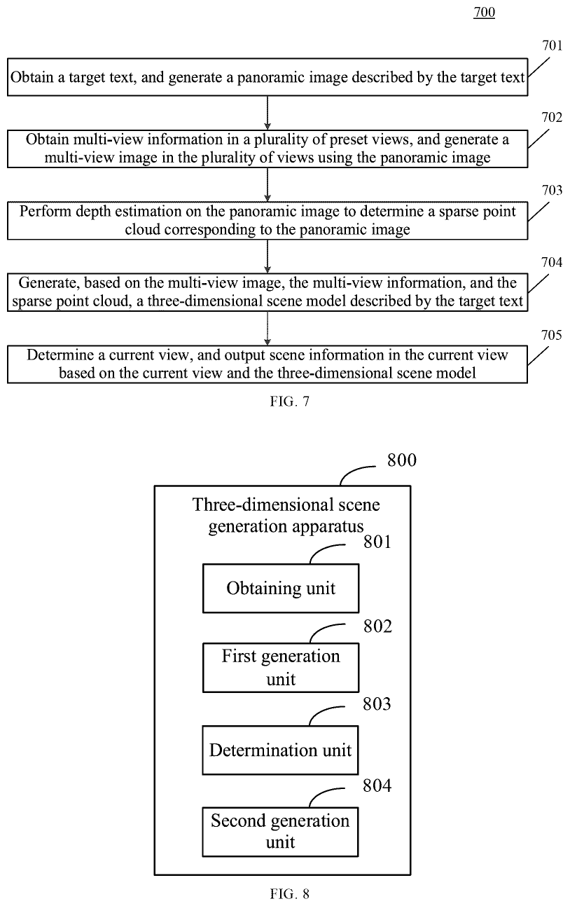

Further, reference is made to FIG. 7, which shows a process 700 of still another embodiment of a method for three-dimensional scene generation. The process 700 of the method for three-dimensional scene generation includes the following steps.

Step 701: Obtain a target text, and generate a panoramic image described by the target text.

Step 702: Obtain multi-view information in a plurality of preset views, and generate a multi-view image in the plurality of views with the panoramic image.

Step 703: Perform depth estimation on the panoramic image to determine a sparse point cloud corresponding to the panoramic image.

Step 704: Generate, based on the multi-view image, the multi-view information, and the sparse point cloud, a three-dimensional scene model described by the target text.

In this embodiment, steps 701 to 704 may be performed in a manner similar to that in steps 101 to 104 and are not described in detail herein again.

Step 705: Determine a current view, and output scene information in the current view based on the current view and the three-dimensional scene model.

In this embodiment, an execution body of the method for three-dimensional scene generation may determine the current view, and output the scene information in the current view based on the current view and the three-dimensional scene model.

Herein, the current view may be a user-specified view, and the execution body may determine the scene information corresponding to the current view in the three-dimensional scene model, and output the scene information corresponding to the current view. The scene information may include, but is not limited to, an image and a depth that correspond to the current view.

It can be seen from FIG. 7 that compared with the embodiment corresponding to FIG. 1, the process 700 of the method for three-dimensional scene generation in this embodiment embodies the step of outputting the scene information in the current view based on the current view and the three-dimensional scene model. Therefore, in the solution described in this embodiment, scene information in a view of interest of a user can be outputted to output a more realistic three-dimensional scene to the user, improving the user experience.

Further, reference is made to FIG. 8. As an implementation of the method shown in the above figures, the present application provides an embodiment of an apparatus for three-dimensional scene generation. The apparatus embodiment corresponds to the method embodiment shown in FIG. 1. The apparatus is specifically applicable to various electronic devices.

As shown in FIG. 8, the apparatus 800 for three-dimensional scene generation in this embodiment includes an obtaining unit 801, a first generation unit 802, a determination unit 803, and a second generation unit 804. The obtaining unit 801 is configured to obtain a target text, and generate a panoramic image described by the target text. The first generation unit 802 is configured to obtain multi-view information in a plurality of preset views, and generate a multi-view image in the plurality of views with the panoramic image. The determination unit 803 is configured to perform depth estimation on the panoramic image to determine a sparse point cloud corresponding to the panoramic image. The second generation unit 804 is configured to generate, based on the multi-view image, the multi-view information, and the sparse point cloud, a three-dimensional scene model described by the target text.

In this embodiment, for specific processing of the obtaining unit 801, the first generation unit 802, the determination unit 803, and the second generation unit 804 of the apparatus 800 for three-dimensional scene generation, reference may be made to step 101, step 102, step 103, and step 104 in the embodiment corresponding to FIG. 1.

In some optional implementations, the obtaining unit 801 may further be configured to generate, in the following manner, the panoramic image described by the target text: generating, using a pre-trained target diffusion model, the panoramic image described by the target text, where the target diffusion model is used to represent a correspondence between a text and a panoramic image.

In some optional implementations, the target diffusion model may be a model obtained by performing a target operation on an original diffusion model, the original diffusion model is used to represent a correspondence between a text and a two-dimensional image, and the target operation includes: freezing a parameter of the original diffusion model, and inserting a learnable module into the original diffusion model, wherein the learnable module is configured to convert the two-dimensional image into the panoramic image.

In some optional implementations, the learnable module includes a low-rank matrix obtained by decomposing a parameter matrix of the original diffusion model using a low-rank adaptation technology.

In some optional implementations, the apparatus 800 for three-dimensional scene generation may further include an output unit (not shown in the figure). The output unit is configured to determine a current view, and output scene information in the current view based on the current view and the three-dimensional scene model.

In some optional implementations, the three-dimensional scene model includes a three-dimensional Gaussian radiance field.

In some optional implementations, the apparatus 800 for three-dimensional scene generation may further include an optimization unit (not shown in the figure). The optimization unit may be configured to: for each of the plurality of views, project the three-dimensional Gaussian radiance field to the view, compare a projected image in the view with a multi-view image corresponding to the view, to obtain a loss value, and optimize a parameter of the three-dimensional Gaussian radiance field with the loss value.

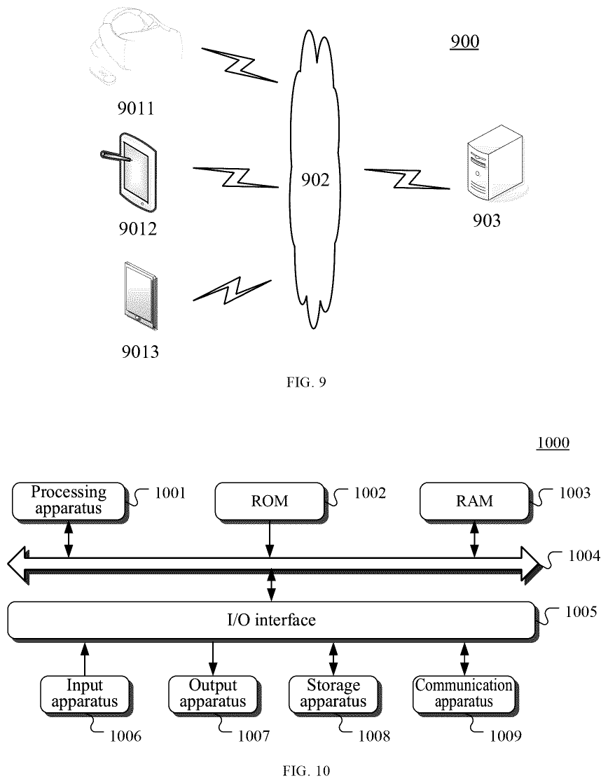

FIG. 9 shows an exemplary system architecture 900 to which an embodiment of a method for three-dimensional scene generation of the present disclosure is applicable.

As shown in FIG. 9, the system architecture 900 may include terminal devices 9011, 9012, and 9013, a network 902, and a server 903. The network 902 is a medium for providing a communication link between the terminal devices 9011, 9012, and 9013 and the server 903. The network 902 may include various connection types, such as wired and wireless communication links or fiber optic cables.

A user may interact with the server 903 through the network 902 using the terminal devices 9011, 9012, and 9013, to send or receive messages, etc. For example, the terminal devices 9011, 9012, and 9013 may obtain a pre-trained target diffusion model from the server 903. The terminal devices 9011, 9012, and 9013 may be installed with various communication client applications, such as a game application, an image capture application, a video processing applications, a video playback application, and instant messaging software.

The terminal devices 9011, 9012, and 9013 may obtain a target text and generate a panoramic image described by the target text; then, obtain multi-view information in a plurality of preset views, and generate a multi-view image in the plurality of views with the panoramic image; next, perform depth estimation on the panoramic image to determine a sparse point cloud corresponding to the panoramic image; and finally, generate, based on the multi-view image, the multi-view information, and the sparse point cloud, a three-dimensional scene model described by the target text.

The terminal devices 9011, 9012, and 9013 may be hardware or software. When the terminal devices 9011, 9012, and 9013 are hardware, the terminal devices 9011, 9012, and 9013 may be various electronic devices having a camera and a display screen and supporting information exchange, including, but not limited to, an extended reality device, a smartphone, a tablet computer, a laptop computer, and the like. When the terminal device 9011, 9012, and 9013 are software, the terminal devices 9011, 9012, and 9013 may be installed on the electronic devices listed above. The terminal devices 9011, 9012, and 9013 may be implemented as a plurality of pieces of software or software modules (such as a plurality of pieces of software or software modules configured to provide distributed services), or may be implemented as a single piece of software or software module. This is not specifically limited herein.

The server 903 may be a server that provides various services. For example, the server 903 may be a backend server that provides a pre-trained target diffusion model for the terminal devices 9011, 9012, and 9013.

It should be noted that the server 903 may be hardware or software. When the server 903 is hardware, the server 903 may be implemented as a distributed server cluster including a plurality of servers, or may be implemented as a single server. When the server 903 is software, the server 903 may be implemented as a plurality of pieces of software or software modules (for example, configured to provide distributed services), or may be implemented as a single piece of software or software module. This is not specifically limited herein.

It should be further noted that if the method for three-dimensional scene generation provided in the embodiments of the present disclosure is usually performed by the terminal devices 9011, 9012, and 9013, the apparatus for three-dimensional scene generation is usually disposed on the terminal devices 9011, 9012, and 9013.

It should be understood that the numbers of terminal devices, networks, and servers in FIG. 9 are merely illustrative. According to implementation needs, there may be any number of terminal devices, networks, and servers.

Reference is made to FIG. 10 below, which is a schematic diagram of a structure of an electronic device (for example, the terminal device in FIG. 9) 1000 suitable for implementing an embodiment of the present disclosure. The electronic device in this embodiment of the present disclosure may include, but is not limited to, mobile terminals such as an extended reality device, a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is merely an example, and shall not impose any limitation on the function and scope of use of the embodiments of the present disclosure.

As shown in FIG. 10, the electronic device 1000 may include a processing apparatus (e.g., a central processing unit or a graphics processing unit) 1001 that may perform a variety of appropriate actions and processing in accordance with a program stored in a read-only memory (ROM) 1002 or a program loaded from a storage apparatus 1008 into a random access memory (RAM) 1003. The RAM 1003 further stores various programs and data required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it should be understood that it is not required to implement or have all of the shown apparatuses. It may be an alternative to implement or have more or fewer apparatuses. Each box shown in FIG. 10 may represent one or more apparatuses as required.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiment of the present disclosure are performed. It should be noted that the computer-readable medium described in this embodiment of the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In this embodiment of the present disclosure, the computer-readable storage medium may be any tangible medium containing or storing a program which may be used by or in combination with an instruction execution system, apparatus, or device. In this embodiment of the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device. The above computer-readable medium carries one or more programs that, when executed by the electronic device, cause the electronic device to: obtaining a target text, and generating a panoramic image described by the target text; obtaining multi-view information in a plurality of preset views, and generating a multi-view image in the plurality of views with the panoramic image; performing depth estimation on the panoramic image to determine a sparse point cloud corresponding to the panoramic image; and generating, based on the multi-view image, the multi-view information, and the sparse point cloud, a three-dimensional scene model described by the target text.

The computer program code for performing the operations in the embodiments of the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The described units may also be disposed in the processor, which may be described, for example, as that the processor includes the obtaining unit, the first generation unit, the determination unit, and the second generation unit. Names of these units do not constitute a limitation on the units themselves in some cases, for example, the obtaining unit may alternatively be described as “a unit for obtaining a target text, and generating a panoramic image described by the target text”.

The foregoing descriptions are merely preferred embodiments of the present disclosure and explanations of the applied technical principles. Those skilled in the art should understand that the scope of the present invention involved in the embodiments of the present disclosure is not limited to the technical solutions formed by particular combinations of the foregoing technical features, and shall also cover other technical solutions formed by any combination of the foregoing technical features or equivalent features thereof without departing from the foregoing concept of the present invention. For example, a technical solution formed by a replacement of the foregoing features with technical features with similar functions disclosed in the embodiments of the present disclosure (but not limited thereto) also falls within the scope of the present disclosure.

I/We claim:

1. A method for three-dimensional scene generation, comprising:
obtaining a target text, and generating a panoramic image described by the target text;
obtaining multi-view information in a plurality of preset views, and generating a multi-view image in the plurality of views with the panoramic image;
performing depth estimation on the panoramic image, to determine a sparse point cloud corresponding to the panoramic image; and
generating, based on the multi-view image, the multi-view information, and the sparse point cloud, a three-dimensional scene model described by the target text.

2. The method according to claim 1, wherein the generating a panoramic image described by the target text comprises:
generating, using a pre-trained target diffusion model, the panoramic image described by the target text, wherein the target diffusion model is used to represent a correspondence between a text and a panoramic image.

3. The method according to claim 2, wherein the target diffusion model is a model obtained by performing a target operation on an original diffusion model, wherein the original diffusion model is used to represent a correspondence between a text and a two-dimensional image, and the target operation comprises: freezing a parameter of the original diffusion model, and inserting a learnable module into the original diffusion model, wherein the learnable module is configured to convert the two-dimensional image into the panoramic image.

4. The method according to claim 3, wherein the learnable module comprises a low-rank matrix obtained by decomposing a parameter matrix of the original diffusion model using a low-rank adaptation technology.

5. The method according to claim 1, wherein the method further comprises:
determining a current view, and outputting scene information in the current view based on the current view and the three-dimensional scene model.

6. The method according to claim 1, wherein the three-dimensional scene model comprises a three-dimensional Gaussian radiance field.

7. The method according to claim 6, wherein the method further comprises:
for each of the plurality of views, projecting the three-dimensional Gaussian radiance field to the view, comparing a projected image in the view with a multi-view image corresponding to the view, to obtain a loss value, and optimizing a parameter of the three-dimensional Gaussian radiance field with the loss value.

8. An electronic device, comprising:
one or more processors; and
a storage apparatus having one or more programs stored thereon, wherein
the one or more programs, when executed by the one or more processors, cause the one or more processors to:
obtain a target text, and generate a panoramic image described by the target text;
obtain multi-view information in a plurality of preset views, and generate a multi-view image in the plurality of views with the panoramic image;
perform depth estimation on the panoramic image, to determine a sparse point cloud corresponding to the panoramic image; and
generate, based on the multi-view image, the multi-view information, and the sparse point cloud, a three-dimensional scene model described by the target text.

9. The device according to claim 8, wherein the programs causing the one or more processors to generate a panoramic image described by the target text comprises programs causing the one or more processors to:
generate, using a pre-trained target diffusion model, the panoramic image described by the target text, wherein the target diffusion model is used to represent a correspondence between a text and a panoramic image.

10. The device according to claim 9, wherein the target diffusion model is a model obtained by performing a target operation on an original diffusion model, wherein the original diffusion model is used to represent a correspondence between a text and a two-dimensional image, and the target operation comprises: freezing a parameter of the original diffusion model, and inserting a learnable module into the original diffusion model, wherein the learnable module is configured to convert the two-dimensional image into the panoramic image.

11. The device according to claim 10, wherein the learnable module comprises a low-rank matrix obtained by decomposing a parameter matrix of the original diffusion model using a low-rank adaptation technology.

12. The method according to claim 8, wherein the programs further cause the one or more processors to:
determine a current view, and output scene information in the current view based on the current view and the three-dimensional scene model.

13. The device according to claim 8, wherein the three-dimensional scene model comprises a three-dimensional Gaussian radiance field.

14. The device according to claim 6, wherein the programs further cause the one or more processors to:
for each of the plurality of views, project the three-dimensional Gaussian radiance field to the view, compare a projected image in the view with a multi-view image corresponding to the view, to obtain a loss value, and optimize a parameter of the three-dimensional Gaussian radiance field with the loss value.

15. A non-transitory computer-readable medium having a computer program stored thereon, wherein the program, when executed by a processor, causing the processor to perform:
obtain a target text, and generate a panoramic image described by the target text;
obtain multi-view information in a plurality of preset views, and generate a multi-view image in the plurality of views with the panoramic image;
perform depth estimation on the panoramic image, to determine a sparse point cloud corresponding to the panoramic image; and
generate, based on the multi-view image, the multi-view information, and the sparse point cloud, a three-dimensional scene model described by the target text.

16. The medium according to claim 15, wherein the programs causing the processors to generate a panoramic image described by the target text comprises programs causing the processors to:
generate, using a pre-trained target diffusion model, the panoramic image described by the target text, wherein the target diffusion model is used to represent a correspondence between a text and a panoramic image.

17. The medium according to claim 16, wherein the target diffusion model is a model obtained by performing a target operation on an original diffusion model, wherein the original diffusion model is used to represent a correspondence between a text and a two-dimensional image, and the target operation comprises: freezing a parameter of the original diffusion model, and inserting a learnable module into the original diffusion model, wherein the learnable module is configured to convert the two-dimensional image into the panoramic image.

18. The medium according to claim 17, wherein the learnable module comprises a low-rank matrix obtained by decomposing a parameter matrix of the original diffusion model using a low-rank adaptation technology.

19. The medium according to claim 15, wherein the programs further cause the processors to:
determine a current view, and output scene information in the current view based on the current view and the three-dimensional scene model.

20. The medium according to claim 15, wherein the three-dimensional scene model comprises a three-dimensional Gaussian radiance field.
